(19) United States
(12) Patent Application Publication
(10) Pub. No.: US 2005/0249441 A1
(43) Pub. Date: Nov. 10, 2005

(54) Air cushioned bearing

(75) Inventors: Chi-Chiang Li, Yangmei Town (TW); Bor-Wen Lin, Yangmei Town (TW)

Correspondence Address: BACON & THOMAS, PLLC, 625 SLATERS LANE, FOURTH FLOOR, ALEXANDRIA, VA, 22314, US

(73) Assignee: Kallex Co. Ltd., Yangmei Town (TW)

(21) Appl. No.: 10/957,641

(22) Filed: Oct. 5, 2004

(30) Foreign Application Priority Data
May 5, 2004 (TW) 093112644

(51) Int. Cl. F16C 32/06

(52) U.S. Cl. 384/114

(57) ABSTRACT

An air cushioned bearing includes: a cylindrical arbor; and an axial bushing formed as a hollow cylindrical tube for rotationally accepting the arbor; wherein a spiral groove or a spiral flange rib is formed between the arbor and the axial bushing. Therefore, the arbor rotates in high speed to form an air cushion between the axial bushing and the arbor.

### BACKGROUND OF THE INVENTION

1. Field of the Invention

The present invention relates to a bearing, and more particularly, to an air cushioned bearing suitable for ultra-high speed, low operating noise environments, such as hard disk drives, optical disk drives or computer cooling fans.

2. Description of the Related Art

Please refer to FIG. 1. FIG. 1 shows a prior art bearing, which comprises an arbor 11 and an axial bushing 12. The axial bushing 12 is hollow for internally accepting the arbor 11 so that the arbor 11 can rotate at high speeds. However, during rotation of the arbor 11, friction between the arbor 11 and the axial bushing 12 leads to excessive heating and material fatigue. In order to avoid these problems, friction between the arbor 11 and the axial bushing 12 must be reduced.

Ball bearings are one of the most popular bearings, in which balls are placed between the arbor and the axial bushing to reduce friction between the arbor and the axial bushing. However, ball bearings are not suitable for environments that demand high rotational speeds, small sizes, low noise, or low costs, which are all frequently desired in high-tech products.

Greased bearing is another popular bearing, which utilizes a porous greased metallic material in the fabrication of the axial bushing so that lubricating oil from the axial bushing reduces friction between the arbor and the axial bushing. However, the high rotational speed of the arbor causes loss of the lubricating oil, or heat generated by friction between the arbor and the axial bushing vaporizes the lubricating oil so that the lubricating oil must be refilled regularly to avoid dry friction between the arbor and the axial bushing, which can otherwise cause serious wear and tear. But this is not practical for many applications, such as hard disk drives, optical disk drives or computer cooling fans.

Therefore, it is desirable to provide an air cushioned bearing to mitigate and/or obviate the aforementioned problems.

### SUMMARY OF THE INVENTION

A main objective of the present invention is to provide an air cushioned bearing that provides advantages such as low polluting characteristics, a low coefficient of friction, a long lifetime, a low operating noise and a high operating efficiency.

In accordance with one aspect of the present invention, the air cushioned bearing comprises: a cylindrical arbor; and an axial bushing formed as a hollow cylindrical tube for rotationally accepting the arbor; wherein a spiral groove is formed between the arbor and the axial bushing.

In accordance with another aspect of the present invention, the air cushioned bearing comprises: a cylindrical arbor; and an axial bushing formed as a hollow cylindrical tube for rotationally accepting the arbor; wherein a spiral flange rib is formed between the arbor and the axial bushing.

The spiral groove or the spiral flange rib is formed between the arbor and the axial bushing. Therefore, the arbor rotates in high speed to form an air cushion between the axial bushing and the arbor.

In accordance with a further aspect of the present invention, the air cushioned bearing comprises: a cylindrical arbor; and an axial bushing formed as a hollow cylindrical tube with a plurality of circularly arranged saw-teeth on an inner wall, with one end of the saw-teeth being more narrow than another end.

Other objects, advantages, and novel features of the invention will become more apparent from the following detailed description when taken in conjunction with the accompanying drawings.

### BRIEF DESCRIPTION OF THE DRAWINGS

FIG. 1 shows a prior art bearing FIG. 2 shows a first embodiment of an air cushioned bearing in accordance with the present invention.

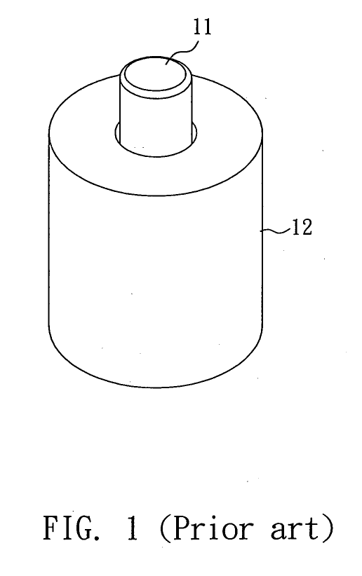

FIG. 3 is a cross-sectional view of an air stream forming when an arbor is rotating in accordance with the first embodiment.

FIG. 4 shows an air cushioned bearing comprising a carrying body in the first embodiment in accordance with the present invention.

FIG. 5 shows an air cushion forming when an arbor is rotating in the first embodiment in accordance with the present invention.

FIG. 6 shows a second embodiment of an air cushioned bearing in accordance with the present invention.

FIG. 7 shows a third embodiment of an air cushioned bearing in accordance with the present invention.

FIG. 8 shows a fourth embodiment of an air cushioned bearing in accordance with the present invention.

FIG. 9 shows a fifth embodiment of an air cushioned bearing in accordance with the present invention.

FIG. 10 shows an air cushion forming when an arbor is rotating in the fifth embodiment in accordance with the present invention.

### DETAILED DESCRIPTION OF THE PREFERRED EMBODIMENT

Please refer to FIG. 2. FIG. 2 shows a first embodiment of an air cushioned bearing in accordance with the present invention. The air cushioned bearing comprises an arbor 21 and an axial bushing 22. The axial bushing 22 is a hollow cylindrical tube for holding and permitting rotation of the arbor. The arbor 21 is cylindrical, and a spiral groove 211 is formed on the surface of the arbor 21.

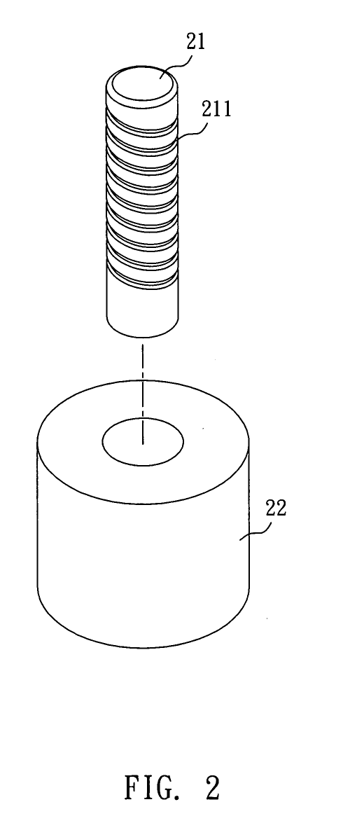

The spiral groove 211 of the arbor 21 winds counterclockwise around the arbor 21, from top to bottom. Therefore, as shown in FIG. 3, when the arbor 21 rotates counterclockwise, air in the spiral groove 211 is pushed by the groove wall and flows down and counterclockwise to form a downward moving air steam.

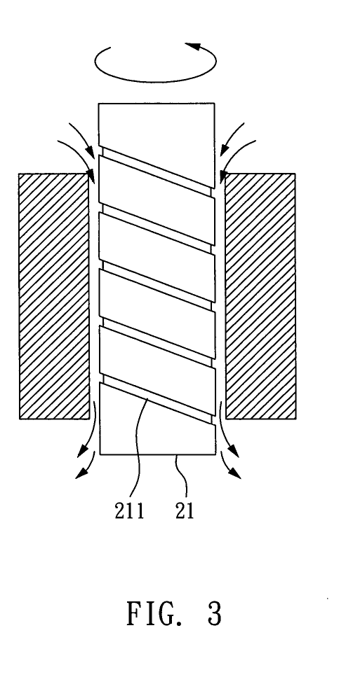

The air steam reduces the friction between the arbor 21 and the axial bushing 22. As shown in FIG. 4, the air cushioned bearing further comprises a carrying body 23, which is a hollow cylindrical body with one open end and one closed end, and which is used for containing the axial bushing 22 and the arbor 21.

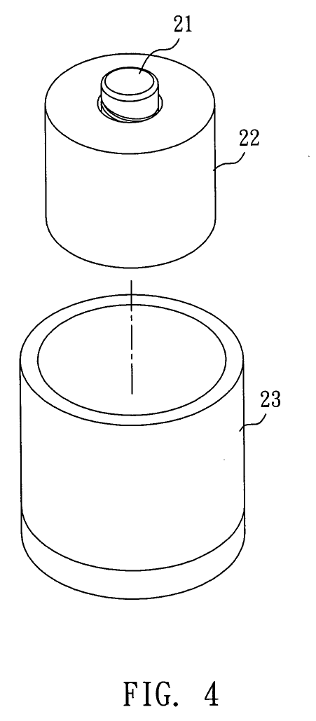

As shown in FIG. 5, when the axial bushing 22 and the arbor 21 are placed in the carrying body 23, the lower end of the axial bushing 22 is sealed. Please refer again to FIG. 3. When the arbor 21 rotates counterclockwise, air moves down while more air enters from the upper end of the axial bushing 22. However, the lower end of the axial bushing 22 is sealed so that the air is compressed between the axial bushing 22 and the arbor 21, forming an air cushion. When the arbor 21 rotates faster, the air is even further compressed. The air cushion is used as a friction buffer layer between the axial bushing 22 and the arbor 21 to efficiently reduce the friction between the axial bushing 22 and the arbor 21.

The spiral groove 211 of the arbor 21 can also be wound clockwise around the inner wall surface of the axial bushing 22 from top to bottom, and the arbor 21 correspondingly rotates clockwise so that an air cushion is formed between the axial bushing 22 and the arbor 21.

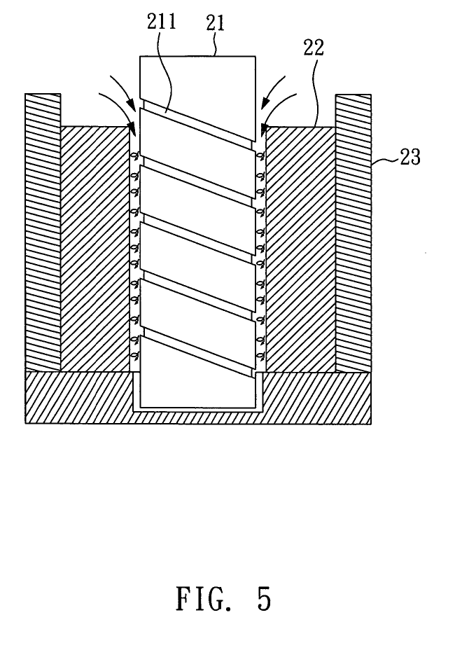

FIG. 6 shows a second embodiment of an air cushioned bearing according to the present invention. The second embodiment is similar to the first embodiment, but the spiral groove 211 is formed on the inner wall surface of the axial bushing 22. The spiral groove 211 is wound counterclockwise around the inner wall surface of the axial bushing 22 from top to bottom, and the arbor 21 rotates counterclockwise, thus creating an air cushion between the axial bushing 22 and the arbor 21; or alternatively, the spiral groove 221 is wound clockwise around the inner wall surface of the axial bushing 22 from top to bottom, and the arbor 21 rotates clockwise to form an air cushion between the axial bushing 22 and the arbor 21.

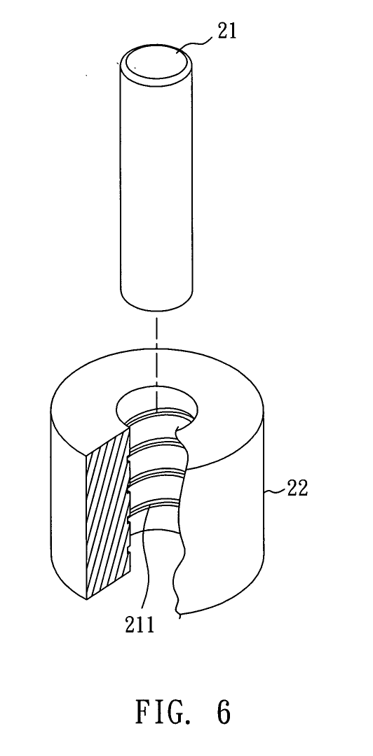

FIG. 7 shows a third embodiment of an air cushioned bearing according to the present invention. The third embodiment is similar to the first embodiment. The difference is that a spiral flange rib 711 is formed on the inner wall surface of the axial bushing 22. The spiral flange rib 711 is wound counterclockwise around the surface of arbor 21 from top to bottom, and the arbor 21 rotates counterclockwise to create an air cushion between the axial bushing 22 and the arbor 21; or alternatively, the spiral flange rib 711 is wound clockwise around the surface of the arbor 21 from top to bottom, and the arbor 21 rotates clockwise to form an air cushion between the axial bushing 22 and the arbor 21.

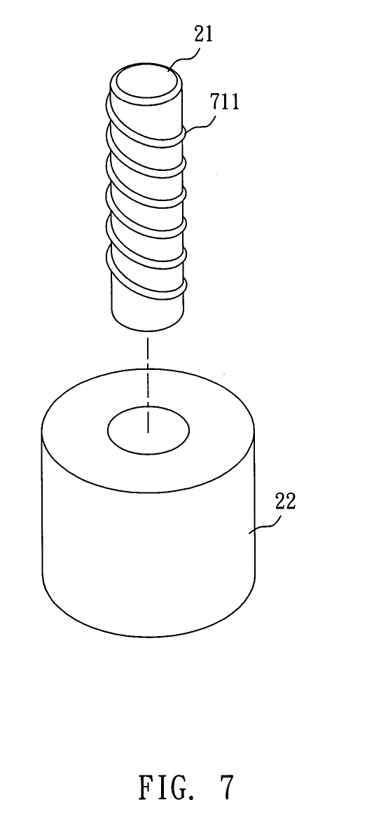

FIG. 8 shows a fourth embodiment of an air cushioned bearing according to the present invention. The fourth embodiment is similar to the first embodiment. The difference is that a spiral flange rib 711 is formed on the surface of the arbor 21. The spiral flange rib 711 is wound counterclockwise around the inner wall surface of the axial bushing 22 from top to bottom, and the arbor 21 rotates counterclockwise to form an air cushion between the axial bushing 22 and the arbor 21; or alternatively, the spiral flange rib 711 is wound clockwise around the inner wall surface of the axial bushing 22 from top to bottom, and the arbor 21 rotates clockwise to form an air cushion between the axial bushing 22 and the arbor 21.

Accordingly, the spiral groove or the spiral flange rib are formed on the surface between the axial bushing 22 and the arbor 21, so that when the arbor 21 rotates at high speeds, the surrounding air streaming between the axial bushing 22 and the arbor 21 forms the air cushion to reduce the friction between the axial bushing 22 and the arbor 21.

In the above-mentioned embodiments, the carrying body 23 is used for sealing the lower end of the axial bushing 22 to form the air cushion; however, when the axial bushing 22 is actually part of an assembly within a machine, the lower end of the axial bushing 22 may be blocked by other parts, and therefore there may be no need to provide for the carrying body 23 to form the air cushion.

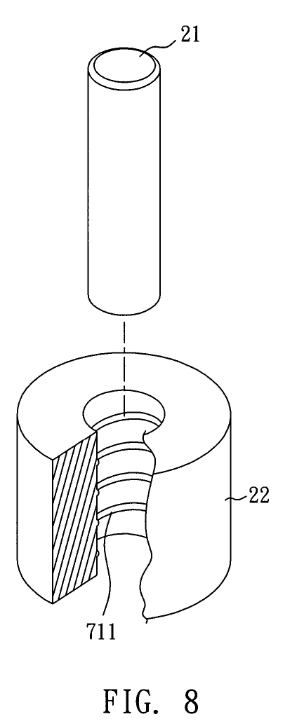

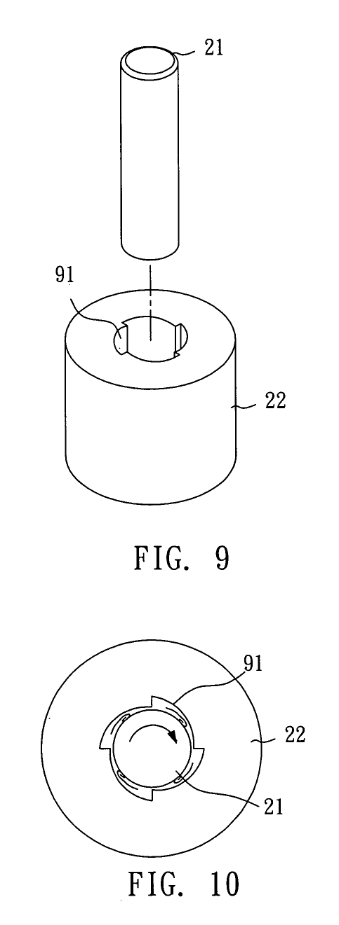

FIG. 9 shows a fifth embodiment of an air cushioned bearing according to the present invention. The fifth embodiment is similar to the first embodiment. The arbor 21 is cylindrical, and the axial bushing 22 is a hollow cylindrical tube with a plurality of circularly arranged saw-teeth 91 on the inner wall, and one end of the saw-teeth 91 is narrower than the other end. Therefore, as shown in FIG. 10, since the saw-teeth 91 are circularly arranged, a gap in the saw-teeth 91 between the axial bushing 22 and the arbor 21 becomes narrower in the clockwise direction (in this embodiment). When the arbor 21 rotates clockwise, the air flows from the wider gap to the narrower gap, and so forms an air cushion between the axial bushing 22 and the arbor 21 to reduce the friction between the axial bushing 22 and the arbor 21.

Although the present invention has been explained in relation to its preferred embodiment, it is to be understood that many other possible modifications and variations can be made without departing from the spirit and scope of the invention as hereinafter claimed.

1. An air cushioned bearing comprising:
a cylindrical arbor; and
an axial bushing formed as a hollow cylindrical tube for rotationally accepting the arbor;
wherein a spiral groove is formed between the arbor and the axial bushing.

2. The air cushioned bearing as claimed in claim 1 further comprising a carrying body formed as a hollow cylindrical body with one open end and one closed end and used for containing the axial bushing and the arbor and sealing the lower end of the axial bushing.

3. The air cushioned bearing as claimed in claim 2, wherein the spiral groove is formed on a surface of the arbor.

4. The air cushioned bearing as claimed in claim 3, wherein the spiral groove is wound counterclockwise around the arbor from a top end to a bottom end, and the arbor rotates counterclockwise.

5. The air cushioned bearing as claimed in claim 3, wherein the spiral groove is wound clockwise around the arbor from a top end to a bottom end, and the arbor rotates clockwise.

6. The air cushioned bearing as claimed in claim 2, wherein the spiral groove is formed on an inner wall surface of the axial bushing.

7. The air cushioned bearing as claimed in claim 6, wherein the spiral groove is wound counterclockwise around the inner wall surface of the axial bushing from a top end to a bottom end, and the arbor rotates counterclockwise.

8. The air cushioned bearing as claimed in claim 6, wherein the spiral groove is wound clockwise around the inner wall surface of the axial bushing from a top end to a bottom end and the arbor rotates clockwise.

9. An air cushioned bearing comprising:
a cylindrical arbor; and
an axial bushing formed as a hollow cylindrical tube for rotationally accepting the arbor;
wherein a spiral flange rib is formed between the arbor and the axial bushing.

10. The air cushioned bearing as claimed in claim 9 further comprising a carrying body formed as a hollow cylindrical body with one open end and one closed end and used for containing the axial bushing and the arbor and sealing the lower end of the axial bushing.

11. The air cushioned bearing as claimed in claim 10, wherein the spiral flange rib is formed on a surface of the arbor.

12. The air cushioned bearing as claimed in claim 11, wherein the spiral flange rib is wound counterclockwise around the arbor from a top end to a bottom end, and the arbor rotates counterclockwise.

13. The air cushioned bearing as claimed in claim 11, wherein the spiral flange rib is wound clockwise around the arbor from a top end to a bottom end, and the arbor rotates clockwise.

14. The air cushioned bearing as claimed in claim 10, wherein the spiral flange rib is formed on an inner wall surface of the axial bushing.

15. The air cushioned bearing as claimed in claim 14, wherein the spiral flange rib is wound counterclockwise around the inner wall surface of the axial bushing from a top end to a bottom end, and the arbor rotates counterclockwise.

16. The air cushioned bearing as claimed in claim 14, wherein the spiral flange rib is wound clockwise around the inner wall surface of the axial bushing from a top end to a bottom end, and the arbor rotates clockwise.

17. An air cushioned bearing comprising:
a cylindrical arbor; and
an axial bushing formed as a hollow cylindrical tube with a plurality of circularly arranged saw-teeth on an inner wall, with one end of the saw-teeth being narrower than another end.
